(19) United States
(12) Patent Application Publication
(10) Pub. No.: US 2015/0235257 A1
(43) Pub. Date: Aug. 20, 2015

(54) Method and system to dispatch a car

(71) Applicant: SHIH PI TA TECHNOLOGY LTD., Taipei City (TW)

(72) Inventor: Jen-Chang WU, TAIPEI CITY (TW)

(21) Appl. No.: 14/527,766

(22) Filed: Oct. 29, 2014

(30) Foreign Application Priority Data
Feb. 17, 2014 (TW) 103105140

(51) Int. Cl. G06Q 30/02; G06Q 50/30

(52) U.S. Cl. CPC G06Q 30/0233; G06Q 50/30

(57) ABSTRACT

A method to dispatch a car in a dispatch center is disclosed. First, a car dispatch request from a passenger is received. Then, according to the car dispatch request, a step to determine whether the passenger uses his reward points to exchange a priority for dispatching a car is performed. When the passenger uses his reward points to exchange the priority, a step to determine whether his reward points are larger than the required points to exchange the priority is performed. When his reward points is larger than the required points, the dispatch center according to the priority to dispatch a car. The reward points for exchanging the priority are transferred to the driver.

### RELATED APPLICATIONS

This application claims priority to Taiwan Application Serial Number 103105140, filed Feb. 17, 2014, the entirety of which is herein incorporated by reference.

### BACKGROUND

1. Field of Invention

The invention relates to a method to dispatch a car, and particularly relates to a method and system to dispatch a car according to a priority, wherein a passenger uses his reward points to exchange this priority.

2. Description of Related Art

When a passenger wants to take a taxi, he or she can call a dispatching center to request a taxi. After receiving a car dispatch request, an operator of the dispatching center broadcasts the request to all the taxi drivers near the passenger through radio communication. The operator notifies taxi drivers who are near the passenger's location, and asks if any of the taxi drivers can carry the passenger on time. Then, the taxi drivers inform the dispatching center if they are willing to take the passenger. Typically, a GPS system is used to locate the positions of the passenger and the drivers to facilitate the accomplishment of the car dispatch request.

Such dispatching method is normally able to meet the car dispatch request in off-peak hours for passengers. However, during peak hours, passengers often need to spend more time to complete the car dispatch request. Even though the passenger is a loyal customer who always calls a same dispatching center to request a taxi, he or she also needs to wait for a reply of an empty taxi without privilege, which may make the loyal consumer try other dispatching centers to call a taxi. It is adverse to the business of a dispatching center.

Therefore, it is a goal to satisfy the loyal consumers as well as balance the interests of other consumers, and even let other consumers become loyal consumers.

### SUMMARY

Accordingly, the present invention provides a method to dispatch a car. According to the method, a consumer can use reward points to exchange a priority for dispatching a car in peak hours. For a loyal consumer, he can use reward points got in off-peak hours to exchange a priority for dispatching a car in peak hours. For other consumers, they need to become loyal consumers for earning reward points to exchange a priority for dispatching a car in peak hours to achieve the purpose of win-win.

The invention provides a method to dispatch a car. The method is used in a dispatch center. First, a car dispatch request from a passenger is received. Then, according to the car dispatch request, a determination step is performed to determine whether or not the passenger uses his reward points to exchange a priority for dispatching a car. When the passenger uses his reward points to exchange a priority for dispatching a car, a determination step is performed to determine whether or not his reward points is larger than the required points to exchange a priority for dispatching a car. When his reward points is larger than the required points to exchange a priority for dispatching a car, the dispatch center according to the priority to dispatch a car. When a vacant taxi is in the dispatching range of the passenger, the vacant taxi is dispatched to the passenger to provide a service. The reward points for exchanging the priority for dispatching a car are transferred to the driver who provides the service.

In an embodiment, when his reward points is less than the required points to exchange a priority for dispatching a car, a determination step is performed to determine whether or not to provide an online trading system to the passenger. The online trading system provides different numbers of reward points for the passenger to purchase.

In an embodiment, when it is not necessary to provide the online trading system to the passenger, the dispatching center dispatches a car to the passenger according to an order of the car dispatch request from the passenger

In an embodiment, when the online trading system is provided to the passenger, the passenger can trade the reward points in the online trading system.

In an embodiment, after the reward points for exchanging the priority for dispatching a car are transferred to the driver who provides the service, the drivers can upload the reward points to the online trading system to trade.

In an embodiment, when the passenger does not use his reward points to exchange a priority for dispatching a car, the dispatching center dispatches a car to the passenger according to an order of the car dispatch request from the passenger.

In an embodiment, the passenger is an enterprise customer.

In an embodiment, after the reward points for exchanging the priority for dispatching a car are transferred to the driver who provides the service, the drivers can use the reward points to offset the service charges of the dispatch center or to exchange bonus.

In an embodiment, after the reward points for exchanging the priority for dispatching a car are transferred to the driver who provides the service, the drivers can use the reward points to exchange a priority for the dispatching center to dispatch the drivers car.

In an embodiment, when a car dispatch request from the passenger to the dispatching center is in the off-peak hours, the dispatching center give a predetermined number of reward points to the passenger.

In an embodiment, the number of the reward points of the passenger is recorded in a member database.

The invention also provides an apparatus to dispatch a car. The apparatus is used in a dispatch center. The dispatching center receives a car dispatch request from a passenger. Then, according to the car dispatch request, a first determination apparatus determines whether or not the passenger uses his reward points to exchange a priority for dispatching a car. When the passenger uses his reward points to exchange a priority for dispatching a car, a second determination apparatus determines whether or not the passengers reward points is larger than the required points to exchange a priority for dispatching a car. When the passengers reward points is larger than the required points to exchange a priority for dispatching a car, a dispatch apparatus according to the priority to dispatch a car. When a vacant taxi is in the dispatching range of the passenger, the vacant taxi is dispatched to the passenger to provide a service. A member database records the number of the passengers reward points. The passengers reward points for exchanging the priority for dispatching a car are transferred to the driver who provides the service.

In an embodiment, the apparatus further comprises a third determination apparatus to determine whether or not to provide an online trading system to the passenger. The online trading system provides different numbers of reward points for the passenger to purchase.

In an embodiment, when the third determination apparatus determines that it is not necessary to provide the online trading system to the passenger, the dispatching apparatus dispatches a car to the passenger according to an order of the car dispatch request from the passenger.

In an embodiment, when the third determination apparatus determines to provide the online trading system to the passenger, the passenger can trade the reward points in the online trading system.

In an embodiment, when the first determination apparatus determines that the passenger does not use his reward points to exchange a priority for dispatching a car, the dispatching apparatus dispatches a car to the passenger according to an order of the car dispatch request from the passenger.

Accordingly, a dispatching center uses reward points to attract the passengers to call taxis and then to make the passengers become the loyal consumers of the dispatching center. Then, the dispatching center can use reward point mechanisms to consolidate the loyalty of the loyal consumers to achieve the goal of win-win.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 illustrates a flow chart of using reward points for exchanging a priority to dispatch a car according to an embodiment of the invention;

FIG. 2 illustrates a system of using reward points for exchanging a priority to dispatch a car according to an embodiment of the invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts. It is noted that, in accordance with the standard practice in the industry, various features are not drawn to scale. In fact, the dimensions of the various features may be arbitrarily increased or reduced for clarity of discussion.

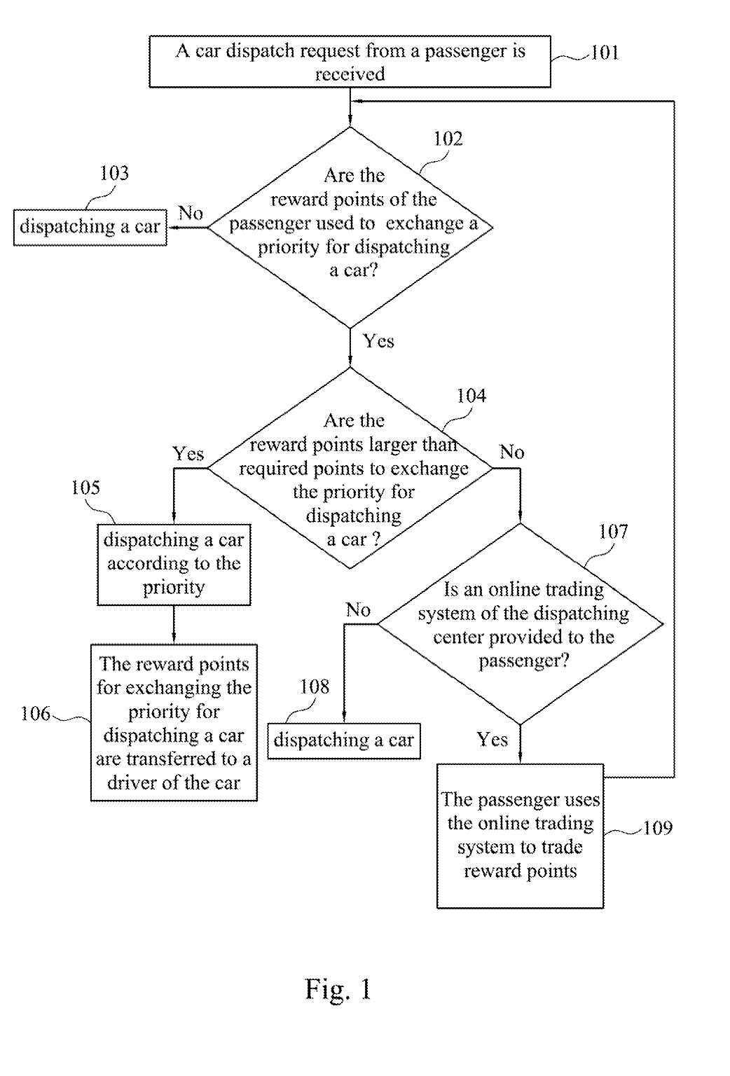

FIG. 1 illustrates a flow chart of using reward points for exchanging a priority to dispatch a car according to an embodiment of the invention. First, in step 101, a car dispatch request from a passenger is received. In an embodiment, the passenger can use a telephone, a mobile phone, an application program, a web page of a dispatching center, a multimedia kiosk or a fax to transfer the car dispatch request to the dispatching center. When the dispatching center receives the car dispatch request, the dispatching center will send a vacant taxi near the passenger to provide service. In an embodiment, the dispatching center uses a GPS system to find this vacant taxi. For example, when a wireless unit with GPS function disposed in a taxi receives a GPS signal, the wireless unit can transfer this GPS signal to the dispatch center. The position of this taxi is displayed in a map by the dispatching center according to the GPS signal. Then, an employee of the dispatching center may know the positions of the taxi and the passenger. The employee notifies drivers around the passenger's location and asks if the drivers are willing to carry the passenger. The drivers inform the dispatching center if they are willing to carry the passenger. Then, a driver who informs the dispatching center first is selected to carry the passenger. The foregoing dispatching method is a typical dispatching method. That is, when there is a vacant taxi around the passenger's location, the passenger can use the foregoing dispatching method to get service. It is not necessary for the passenger to spend a lot of time to complete his car dispatch request. However, when there is no vacant taxi around the passenger's location but the passenger wants to get taxi service fast, he can use his reward points to exchange a priority for dispatching a car in the claimed invention. In an embodiment, a dispatching center uses reward points to attract the passengers to use its taxi service in off-peak hours. That is, when a passenger issues a car dispatch request to a dispatch center in off-peak, and when the dispatch center finishes the car dispatch request, the passenger can get reward points from the dispatching center. The reward points may be accumulated. Therefore, the passenger can use his reward points to exchange a priority for dispatching a car in peak hours. In an embodiment, the dispatching center sets a special account number for the passenger. The reward points are recorded under the special account number.

Accordingly, in step 102, according to the car dispatch request, a determination step is performed to determine whether or not the passenger uses his reward points to exchange a priority for dispatching a car. In an embodiment, when there is no vacant taxi around the passenger's location, the dispatching center may ask the passenger whether or not he wants to use his reward points to exchange a priority for dispatching a car. That is, once there is a vacant taxi around the passengers location, this vacant taxi is dispatched to the passenger first. It is not necessary for the passenger to wait a dispatched taxi according to the order of sending car dispatch request to the dispatching center. Therefore, if the passenger wants to get taxi service fast, he can use reward points to exchange a priority for dispatching a car.

If the passenger does not want to use his reward points to exchange a priority for dispatching a car, in step 103, the dispatching center performs a typical dispatching process. That is, the dispatching center dispatches a vacant taxi to carry the passenger according to the order of he sending car dispatch request to the dispatching center. On the other hand, if the passenger wants to use his reward points to exchange a priority for dispatching a car, in step 104, a determination step is performed to determine whether or not his reward points is larger than the required points to exchange a priority for dispatching a car. That is to determine whether or not the number of the reward points recorded under the passenger's account number is larger than the required points to exchange a priority for dispatching a car.

Once the reward points recorded under the passenger's account number is larger than the required points to exchange a priority for dispatching a car, in step 105, the dispatch center according to the priority to dispatch a car. That is, when there is a vacant taxi around the passenger's location, this vacant taxi is dispatched to the passenger first. In an embodiment, the dispatching center may transfer the priority to dispatch a car information and the number of reward points to exchange the priority information to the vacant taxis. In another embodiment, if there is more than one taxi around the passenger's location, the foregoing information is transferred to these taxis and asks if the drivers of the taxis are willing to carry the passenger. Then, a driver who informs the dispatching center first is selected to carry the passenger.

Then, in step 106, the number of the reward points for exchanging the priority for dispatching a car is transferred to the driver who provides the service. That is, if the driver of the vacant taxi finishes to carry the passenger, the number of reward points to exchange the priority is transferred to the driver. In an embodiment, the dispatching center sets a special account number for the driver. After the driver of the vacant taxi finishes to carry the passenger, the reward points to exchange the priority fro dispatching a car recorded under the passenger's account number is transferred to the driver's account number according to a ratio. In an embodiment, the ratio is “1”. That is, all reward points used to exchange the priority are transferred to the driver's account number from the passenger's account number. In another embodiment, the ratio is “50%”. That is, 50% of reward points used to exchange the priority are transferred to the driver's account number from the passenger's account number. The other 50% of reward points belongs to the dispatching center. It is noticed that the ratio can be set by the dispatching center. In an embodiment, the driver can use his reward points to exchange gift with the dispatching center, to offset the service charges of the dispatch center, to exchange bonus or to upload the reward points to an online trading system for trading which will be detailed described in the following paragraphs. in another embodiment, the driver can also use his reward points to exchange a priority of the dispatching center to dispatch the driver's car. That is, in the off-peak hours, when the dispatching center receives a car dispatching request, the dispatching center transfers the car dispatching request to the driver first to ask the driver whether or not is willing to carry the passenger. If the driver is willing to carry the passenger, the reward points is directly subtract from the driver's account by the dispatching center.

On the other hand, if the reward points recorded under the passenger's account number is less than the required points to exchange a priority for dispatching a car in step 104, a determination step 107 is performed to determine whether or not to provide an online trading system to the passenger. That is, when the passenger's reward points is not enough to require a priority for dispatching a car, the dispatching center may ask the passenger whether or not to enter the online trading system to trade other reward points to meet the required points to ask the priority. If the passenger does not want to trade other reward points in the online trading system, in step 108, the dispatching center performs a typical dispatching process. That is, the dispatching center dispatches a vacant taxi to carry the passenger according to the order of he sending car dispatch request to the dispatching center. On the other hand, if the passenger wants to trade other reward points in the online trading system, in step 109, the dispatching center provides the online trading system to the passenger. In an embodiment, the online trading system provides different numbers of reward points for the passenger to trade. These reward points are arranged according to price or number. In an embodiment, if the car dispatching center request is transferred to the dispatching center by voice, the online trading system broadcasts the number and the price of the reward points to the passenger to select by voice. In another embodiment, if the passenger uses the web-page of the car dispatching center to transfer the car dispatching request, the online trading system is displayed in the web-page to the passenger to select he wanted reward points.

Accordingly, when a passenger uses the dispatching center's taxi service in off-peak, the passenger can gat reward points from the dispatching center. Then, the passenger can use the online trading system to trade the reward points to get an additional profit and to improve the liquidity of rewards points. Moreover, the dispatching center can use reward point mechanisms to consolidate the loyalty of the loyal consumer. The dispatching center also can use the reward points to attract the passengers to call taxi service and then to make the passengers become the loyal consumers of the dispatching center. On the other hand, the passenger can be an enterprise customer. That is, an employee of an enterprise can use a same account as the enterprise customer to accumulate the reward points. After the passenger finishes his trading in the online trading system, the step 102 is performed again to dispatch a car

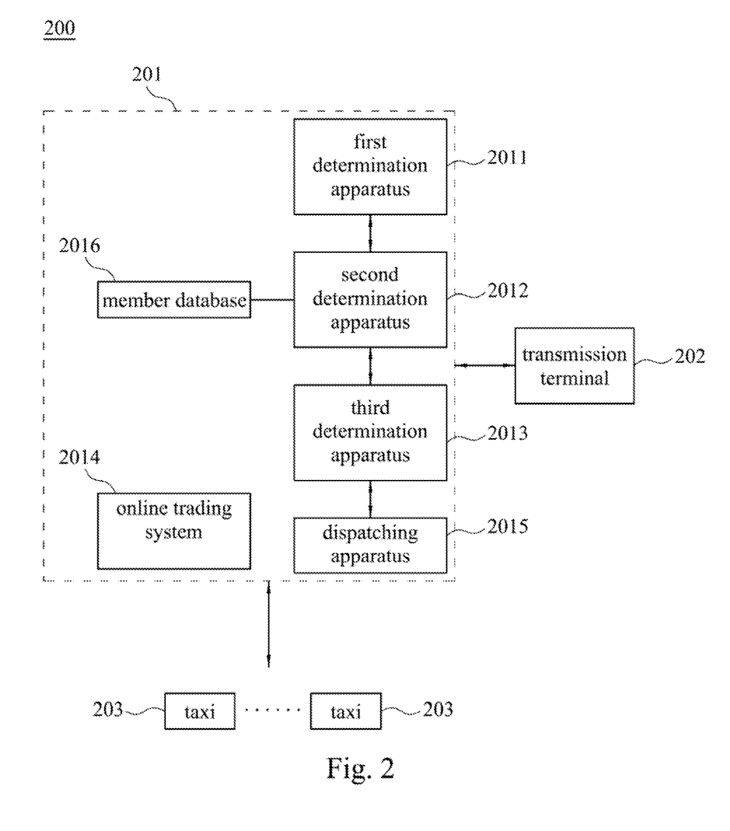

FIG. 2 illustrates a system of using reward points for exchanging a priority to dispatch a car according to an embodiment of the invention. The system 200 comprises a dispatching terminal 201, a transmission terminal 202 for transferring a car dispatch request and taxis 203. The transmission terminal 202 is a telephone, a mobile phone, an application program, a web page of a dispatching center, a multimedia kiosk or a fax. A passenger uses the transmission terminal 202 to transfer a car dispatch request to the dispatching terminal 201. The dispatching terminal 201 comprises a first determination apparatus 2011, a second determination apparatus 2012, a third determination apparatus 2013, an online trading system 2014, a dispatching apparatus 2015 and a member database 2016.

When the dispatching terminal 201 receives a car dispatch request from the transmission terminal 202, the first determination apparatus 2011 determines whether or not the passenger of the transmission terminal 202 wants to use his reward points to exchange a priority for dispatching a car. In an embodiment, when there is no vacant taxi around the transmission terminal 202, the passenger, location, the first determination apparatus 2011 may ask the passenger whether or not he wants to use his reward points to exchange a priority for dispatching a car. Then, according to the reply of the transmission terminal 202, the dispatching terminal 201 performs a typical dispatching process or a priority dispatching process. If the transmission terminal 202, the passenger, does not want to use his reward points to exchange a priority for dispatching a car, the first determination apparatus 2011 notifies the dispatching terminal 201 to perform a typical dispatching process. That is, the dispatching terminal 201 dispatches a vacant taxi to carry the passenger according to the order of the transmission terminal 202 sending the car dispatch request to the dispatching terminal 201. On the other hand, if the transmission terminal 202 wants to use his reward points to exchange a priority for dispatching a car, a second determination apparatus 2012 accesses the reward points from the member database 2016 according to the account of the transmission terminal 202. The second determination apparatus 2012 determines whether or not the reward points of the transmission terminal 202 is larger than the required points to exchange a priority for dispatching a car.

When the second determination apparatus 2012 determines the reward points of the transmission terminal 202 is larger than the required points to exchange a priority for dispatching a car, the second determination apparatus 2012 informs the dispatching terminal 201 to perform a priority dispatching process. That is, when there is a vacant taxi 203 around the transmission terminal 202 location, this vacant taxi 203 is dispatched to the transmission terminal 202 first by the dispatching terminal 201. When this vacant taxi 203 carries the passenger, the transmission terminal 202, the second determination apparatus 2012 transfers the reward points for exchanging the priority for dispatching a car recorded under the passenger's account number to the driver's account number.

On the other hand, when the second determination apparatus 2012 determines the reward points of the transmission terminal 202 is less than the required points to exchange a priority for dispatching a car, the third determination apparatus 2013 asks the transmission terminal 202 whether or not wants to trade the reward points in an online trading system 2014. If the transmission terminal 202 does not want to trade reward points in the online trading system 2014, the third determination apparatus 2013 informs the dispatching terminal 201 to perform a typical dispatching process. That is, the dispatching terminal 20 dispatches a vacant taxi to carry the passenger according to the order of the transmission terminal 202 sending the car dispatch request to the dispatching terminal 201. On the other hand, If the transmission terminal 202 wants to trade reward points in the online trading system 2014, the third determination apparatus 2013 couples the transmission terminal 202 with the online trading system 2014 in the dispatching terminal 201. In an embodiment, the online trading system 2014 provides different numbers of reward points for the transmission terminal 202 to trade. These reward points are arranged according to price or number. In an embodiment, the online trading system 2014 broadcasts the number and the price of the reward points to the transmission terminal 202 to select by voice. The first determination apparatus 2011, the second determination apparatus 2012 and the third determination apparatus 2013 are servers.

Accordingly, a dispatching center uses reward points to attract the passengers to call taxi service and then to make the passengers become the loyal consumers of a dispatching center. The dispatching center also can use the reward point mechanisms to consolidate the loyalty of the loyal consumers. Moreover, the passenger can use an online trading system to trade his reward points to get an additional profit and to improve the liquidity of rewards points to achieve the goal of win-win.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method to dispatch a car for a dispatching center, comprising:
receiving a car dispatch request from a passenger;
determining whether or not the passenger uses reward points of the passenger to exchange a priority for dispatching a car according to the car dispatch request;
determining whether or not the reward points are larger than required points to exchange the priority for dispatching a car when the passenger uses the reward points to exchange the priority for dispatching a car;
dispatching a car by the dispatch center according to the priority for dispatching a car when the reward points are larger than the required points to exchange the priority for dispatching a car, wherein when a vacant taxi is in a dispatching range of the passenger, the vacant taxi is dispatched to the passenger; and
transferring the reward points of the passenger for exchanging the priority for dispatching a car to a driver of the vacant taxi.

2. The method of claim 1, further comprising determining whether or not to provide an online trading system of the dispatching center to the passenger when the reward points are less than the required points, wherein the online trading system provides different numbers of reward points for the passenger to purchase.

3. The method of claim 2, further comprising dispatching a car to the passenger by the dispatching center according to an order of the car dispatch request from the passenger when the passenger does not use the online trading system to trade reward points.

4. The method of claim 2, wherein when the online trading system is provided to the passenger, the passenger is allowed to trade the reward points in the online trading system.

5. The method of claim 2, further comprising uploading the reward points transferred form the passenger to the online trading system to trade by the driver.

6. The method of claim 1, further comprising dispatching a car to the passenger by the dispatching center according to an order of the car dispatch request from the passenger when the passenger does not use reward points to exchange a priority for dispatching a car.

7. The method of claim 1, wherein the passenger is an enterprise customer.

8. The method of claim 1, further comprising using the reward points transferred form the passenger to offset a service charge of the dispatch center or to exchange bonus by the driver.

9. The method of claim 1, further comprising when the reward points of the passenger are transferred to the driver, the driver can use the reward points to exchange a priority for the dispatching center to dispatch car.

10. The method of claim 1, further comprising rewarding a predetermined reward points to the passenger when the dispatching center finishes a car dispatch request from the passenger in the off-peak hours.

11. The method of claim 1, further comprising recording the reward points of the passenger in a member database.

12. A system to dispatch a car for a dispatching center, the dispatching center configured to receive a car dispatch request from a passenger, the system comprising:
a first determination apparatus for determining whether or not the passenger uses reward points of the passenger to exchange a priority for dispatching a car according to the car dispatch request;
a second determination apparatus for determining whether or not the reward points are larger than required points to exchange the priority for dispatching a car when the passenger uses the reward points to exchange the priority for dispatching a car;
a dispatching apparatus for dispatching a car according to the priority for dispatching a car when the reward points are larger than the required points to exchange the priority for dispatching a car, wherein when a vacant taxi is in a dispatching range of the passenger, the dispatching apparatus dispatches the vacant taxi to the passenger; and
a member database for recording the reward points of the passenger, wherein the reward points for exchanging the priority for dispatching a car is transferred to a driver of the vacant taxi in the member database.

13. The system of claim 12, further comprising a third determination apparatus to determine whether or not to provide an online trading system of the dispatching center to the passenger when the reward points are less than the required points, wherein the online trading system provides different numbers of reward points for the passenger's purchase.

14. The system of claim 13, wherein when the third determination apparatus determines the passenger does not want to use the online trading system to trade reward points, the dispatching center dispatches a car to the passenger according to an order of the car dispatch request from the passenger.

15. The system of claim 13, wherein when the third determination apparatus determines the online trading system is provided to the passenger, the passenger is allowed to trade the reward points in the online trading system.

16. The system of claim 12, wherein when the first determination apparatus determines the passenger does not use reward points to exchange a priority for dispatching a car, the dispatching center dispatches a car to the passenger according to an order of the car dispatch request from the passenger.
